(19) United States
(12) Patent Application Publication
(10) Pub. No.: US 2012/0206112 A1
(43) Pub. Date: Aug. 16, 2012

(54) High voltage oscilloscope

(76) Inventor: John Kissane, Far Hills, NJ (US)

(21) Appl. No.: 12/931,873

(22) Filed: Feb. 14, 2011

(51) Int. Cl. H02P 11/06

(52) U.S. Cl. 322/16

(57) ABSTRACT

The invention described above is a method of producing high voltage alternating current electricity for use in the electrolysis of liquid. The advantages of using high voltage alternating current over just direct current are that there are resonant frequencies for functional groups in any chemical. By using high voltage alternating current instead of just direct current new pathways might be found to produce chemicals. Possibly even the production of synthetic fuels. My invention is a tool for use in this experimentation. The high voltage oscilloscope provides for means of controlling both frequency and voltage at a specific test site.

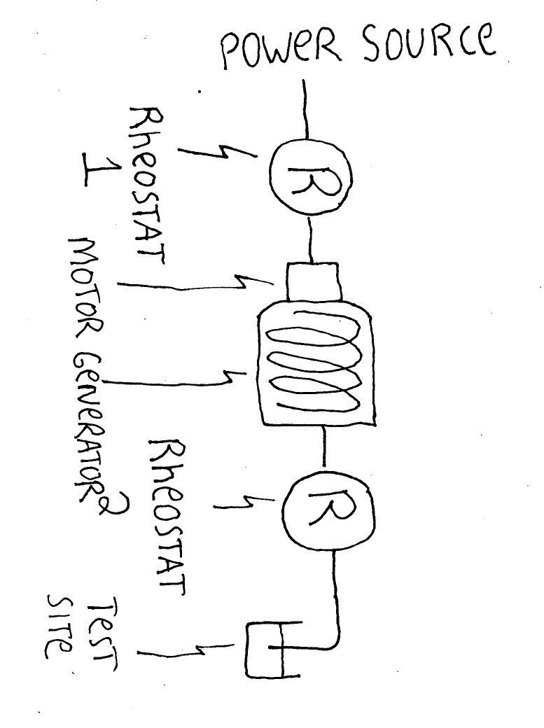

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Electrolysis is a known tool in the field of chemistry. The direct application of electricity to a sample of water yields hydrogen and oxygen for instance. Oscilloscopes have been around for years. With an oscilloscope you can vary both frequency and voltage. However all the oscilloscopes that are manufactured today are used for electronics and therefore operate at low voltages. My idea is to make a high voltage oscilloscope that can be used for electrolysis where you could vary the frequency and voltage of electricity directed at the sample at high voltages that you cannot get with the oscilloscopes that are manufactured today. This could be useful because the experimenter could hone in on the sample with frequencies that are compatible with hydroxyl groups or double bonds while having enough voltage to break a chemical bond. The oscilloscopes made today are not strong enough to do this.

### BRIEF SUMMARY OF THE INVENTION

The invention has a high voltage motor generator powered by a power source and controlled by a rheostat (rheostat 1). Because this rheostat controls how fast the generator spins it also controls the frequency produced by said generator at the test site. The second rheostat (rheostat 2) is located after the generator and therefore controls the voltage of said generator at the test site. Therefore my invention the high voltage oscilloscope has methods of controlling both frequency and voltage at the test site at high voltages.

### BRIEF DESCRIPTION OF THE DRAWING

The drawing shows a motor generator that is powered by a power source and controlled by rheostat 1. The electricity produced by the generator is then controlled by rheostat 2 before it gets to the test site.

### DETAILED DESCRIPTION OF THE INVENTION

Referring more particularly to the drawing . A high voltage motor generator is powered by a power source and controlled by rheostat 1. Because rheostat 1 controls how fast the high voltage generator spins it therefore controls the frequency of the electricity produced by the high voltage generator at the test site. There is also a rheostat 2 that controls the electricity produced by the high voltage generator before it gets to the test site. Therefore rheostat 2 controls the voltage produced by the generator at the test site.

Therefore the described invention has means of controlling both frequency and voltage at the test site. These are the basic controls of an oscilloscope. Furthermore because the generator produces high voltages the invention shows how these high voltages can be controlled by frequency and voltage in a way no standard oscilloscope could do at high voltages.

The application of this high voltage oscilloscope is that it could be used for electrolysis of liquids. Because it can vary both frequency and voltage at the test site in high voltage a researcher can hone in on a molecules frequency and voltage before it breaks. This can be done in alternating current with this high voltage oscilloscope instead of just direct current. Because it can be done in alternating current now at high voltages it might lead to new discoveries by honing in on frequencies that are compatible with double bonds or hydroxyl groups for instance. Furthermore this invention controls high voltage alternating current at the test site for use in experimentation. In the past only direct current was used. The advantages of alternating current with this invention are described above. This might have use in the search for synthetic fuels.

What I claim as my invention is:

1) A method of controlling both frequency and voltage in a high voltage setting for use in the electrolysis of liquids, this control is accomplished by two rheostats placed before and after the motor generator that produces high voltage electricity for the test site, this allows for the control of the high voltage alternating current electricity operating at voltages that a standard oscilloscope cannot.
